(19) United States
(12) Patent Application Publication
(10) Pub. No.: US 2014/0006589 A1
(43) Pub. Date: Jan. 2, 2014

(54) NETWORK CAPABILITY NOTIFICATION

(71) Applicants: Timothy Verrall, Pleasant Hill, CA (US); Dennis M. Morgan, Pine Grove, CA (US)

(72) Inventors: Timothy Verrall, Pleasant Hill, CA (US); Dennis M. Morgan, Pine Grove, CA (US)

(21) Appl. No.: 13/534,535

(22) Filed: Jun. 27, 2012

(51) Int. Cl. H04L 12/26

(52) U.S. Cl. CPC H04L 12/2634
USPC 709/224

(57) ABSTRACT

An initiator device may transmit a message to a network tester requesting initiation of testing of a network connection between the initiator device and a remote entity. The network tester may perform testing including the transmission of test information to, and the reception of test information from, the initiator device and the remote entity. The network tester may monitor the performance of the network connection during testing, and based on the performance may determine capability information. The capability information may then be provided to at least the initiator device. The initiator device may use the performance information to notify the user of the initiator device as to whether capabilities are supported by the network connection and/or to notify about other available network connections, to suggest a network connection, etc. The initiator device may also provide the capability information to applications, which may utilize the capability information in configuring operation, etc.

### BACKGROUND

Electronic communication is becoming increasingly necessary for everyday interactions. No matter the location, users may need to connect to the Internet to transmit and receive data, to conduct voice or video conferencing, etc. In many instances communication may be established over unfamiliar connections. For example, users may plug into a wired hotel or airport network or may couple wirelessly to an access point in a coffee shop, restaurant, store, etc. The quality of the immediate connection (e.g., from a user device to the access point) may be evident to the user in the form of, for example, a connection speed, a graphical indicator (e.g., a number of bars that represents the strength of a wireless signal), etc. However, regardless of whether the immediate connection location is home, work or new to the user, no visibility exists as to what lies beyond.

In particular, users connecting to the Internet may be notified of the performance of their local connection, but do not have visibility as to the capability of the network connection that lies beyond their modem/router. The capability of the entire network connection (e.g., the network components connecting users to their intended destination such as web servers, other users, etc.) is affected by the performance of the individual parts. Beyond the local connection are firewalls, switches, Internet routers and similar elements on the destination end of the network connection. Any one of these network elements may be affected by factors such as traffic, malfunction, etc., which may impact the overall quality of service that can be delivered by the network connection. Currently, the only way for users to determine the capability of the entire network connection is through experimentation, which may be problematic when, for example, business users need to conduct important online meetings, sales presentations, etc., doctors need to view and/or discuss complicated and/or critical medical procedures, people that reside far from each other desire to have a conversation, etc. Often the determination that the capability of a network connection is inadequate for its intended use comes at an instance when it is already too late for users to seek an alternative solution such as establishing a new connection, rescheduling the event, etc.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example system configured for network capability notification in accordance with at least one embodiment of the present disclosure;

FIG. 2 illustrates an example initiator device and network tester usable with at least one embodiment of the present disclosure;

FIG. 3 illustrates an example user interface in accordance with at least one embodiment of the present disclosure;

FIG. 4 illustrates an example user interface including suggestion functionality in accordance with at least one embodiment of the present invention;

FIG. 5 is a flowchart of example operations for network capability notification from the initiator device perspective in accordance with at least one embodiment of the present disclosure; and

FIG. 6 is a flowchart of example operations for network capability notification from the network tester perspective in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

Generally, this disclosure describes systems and methods for network capability notification. An initiator device may need to interact with a remote entity (e.g., a web server, a user device like a smart phone, a tablet computer, etc.) via a network connection. As referenced herein, the network connection may include all network elements connecting the initiator device to the remote entity. A network connection may comprise a local area network (LAN) including, for example, an access point (AP) with which the initiator device is configured to interact via a wired or wireless link, a gateway configured to provide access from the initiator LAN to a wide area network (WAN) such as, for example, the Internet, another gateway configured to provide access from the Internet to a LAN local to the remote entity and the remote entity LAN (e.g., having an AP with which the remote entity is configured to interact via a wired or wireless link).

The initiator device may then be configured to initiate a test of the network connection. In one embodiment, initiation of the network connection may cause the initiator device to initiate the network test. Applications in the initiator device (e.g., applications that transmit and receive data from the Internet such as an Internet browser, a telephone application, a video conferencing application, etc.) may also cause the initiator device to initiate the network test. The initiator device may then be configured to transmit a message to the network tester, the message requesting initiation of a network test. In one embodiment the message may also identify the initiator and the remote entity. The network tester (e.g., a server accessible via the Internet) may then be configured to start testing the network connection. For example, the network tester may be configured to transmit test information (e.g., a ping request, a predetermined amount of information, etc.) to the initiator device and remote entity, and to receive test information from the initiator device and remote entity. In one embodiment the network tester may be configured to monitor performance for the transmission and reception of test information, wherein performance may include speed, bandwidth, quality and/or security. The network tester may then be configured to evaluate the performance information to determine the capabilities of the network connection, and may transmit capability information back to at least the initiator device.

After receiving the capability information, a user interface in the initiator device may be configured to provide notification of the network connection capabilities based on the capability information. For example, the user interface may be configured to display a graphical indicator of whether capabilities such as, for example, data, voice and/or video are currently supported by the network connection. In one embodiment, the user interface may be configured to provide a notification of other available network connections (e.g., detected by the initiator device), and may further inquire as to whether testing of the other available network connections should be performed along with a suggestion of at least one available network connection (e.g., to provide a capability not currently supported by the current network connection). Based on input into the user interface (e.g., from a user), the initiator device may then initiate testing for one or more of the other available network connections, and at least one available network connection may be suggested (e.g., to provide the capability not supported by the current network connection). In the same or a different embodiment, the initiator device may also be configured to make the capability information available to applications (e.g., if an application caused the initiator device to initiate the test, the capability information may be provided back to the application). The capability information may then be utilized by the application to, for example, configure itself based on the capabilities supported in the network connection, to alert the user, etc.)

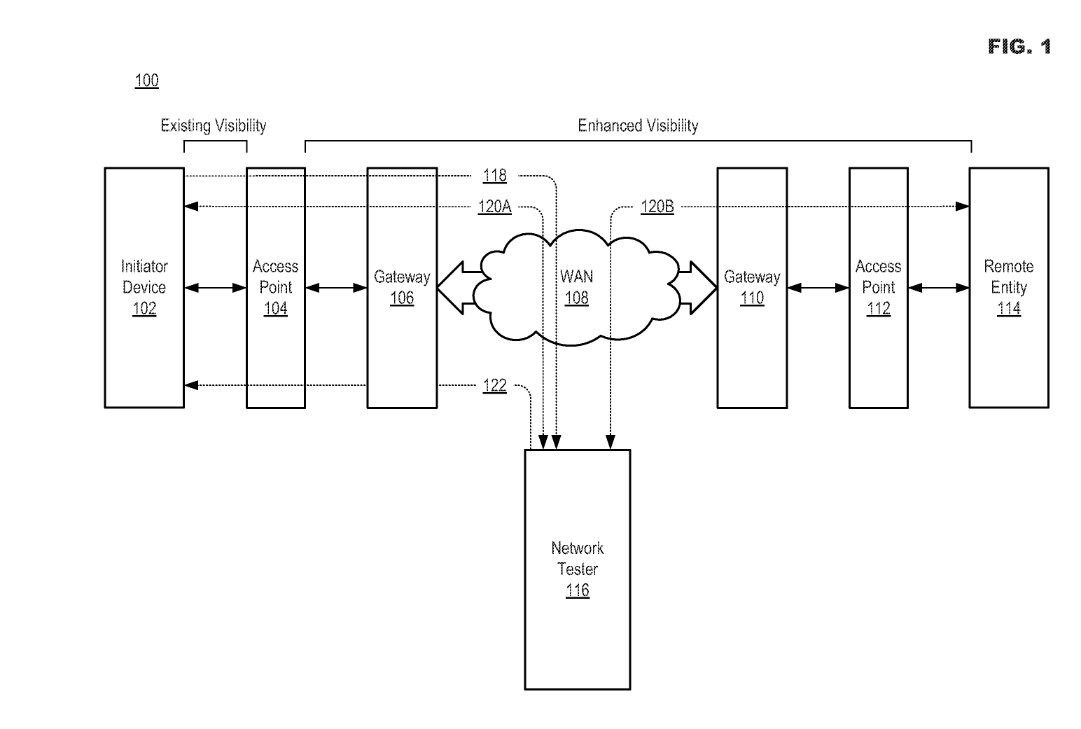

FIG. 1 illustrates example system 100 configured for network capability notification in accordance with at least one embodiment of the present disclosure. System 100 may comprise initiator device 102, AP 104, gateway 106, WAN 108, gateway 110, AP 112, remote entity 114 and network tester 116. Examples of initiator device 102 may include a mobile communication device such as cellular handset or a smartphone based on the Android® operating system (OS), iOS®, Blackberry® OS, Palm® OS, Symbian® OS, etc., a mobile computing device such as a tablet computer like an iPad®, Galaxy Tab®, Kindle Fire®, etc., an Ultrabook® including a low-power chipset manufactured by Intel Corp., a netbook, a notebook computer, a laptop computer, etc. Examples of initiator device 102 may also include typically stationary devices. Stationary systems may include desktop computers with an integrated or separate display, a standalone monitor (e.g., television) capable of WAN (e.g., Internet) communication and/or systems that may comprise a standalone monitor such as a home entertainment system, a videoconferencing system, etc.

At certain instances, initiator device 102 may desire or need to interact with other devices such as remote entity 114. Remote entity 114 may be any of the devices mentioned above with respect to initiator device 102, and may further include any device configured to provide online services or access such as a web server, etc. To interact with remote entity 114, initiator device 102 may be configured to first establish a link to AP 104. AP 104 may be, for example, a router device to which initiator device 102 connects via wired or wireless communication. AP 104 may be configured to handle communications in a LAN including at least initiator device 102 and AP 104, and may further be configured to couple the LAN to a WAN via gateway 106. Gateway 106 may be any device capable of routing communications between two different networks, and may in some instances include firewall technology to control the flow of information between networks. WAN 108 may be, for example, the Internet. WAN 108 may be coupled to another gateway 110 granting access to a LAN including at least AP 112 and remote entity 114. Devices 104-112 may each perform communication-related operations that, when taken in their entirety, establish and maintain a network connection between initiator device 102 and remote entity 114.

Network tester 116 may be any of the devices mentioned above with respect to initiator device 102, and may further include any device configured to perform network testing that may be accessed via WAN 108 (e.g., at least one web server). Network tester 116 may be configured to receive messages requesting the initiation of a network test (e.g., from initiator device 102) as shown at 118, to conduct network testing in accordance with the request as shown at 120A and 120B, to generate capability information based on the results of the network testing, and to transmit the capability information to at least the device that requested the test as shown at 122. Network tester 116 may be configured to perform the above activities on demand, periodically for a certain duration, until initiator device 102 informs network tester 116 that the network connection is no longer in use, etc. As a result, the capability information may be continually updated during the duration where initiator device 102 and remote entity 113 are interacting.

Testing may include, for example, the transmission of test information to initiator device 102 and remote entity 114, and the reception of test information (e.g., the same test information that was previously sent). Test information may include pinging Internet protocol (IP) addresses or universal resource locators (URL) corresponding to initiator device 102 and remote entity 114 with a small amount of data and/or transmitting and receiving at least one set of more substantial test information intended to test transmission and reception performance for each of initiator 102 and remote entity 114. Network tester 116 may monitor the time it takes to transmit and receive the test information, errors, dropped packets, etc. that occur during transmission and reception, the integrity of received test information compared to the test information that was transmitted, etc. to determine overall performance of the network connection. The performance may then be used to determine capability information. In one embodiment, network connection capabilities may correspond to various activities that can occur over a network connection such as, but not limited to, the transmission and reception of data, conducting voice communication, conducting video communication, conducting secure communication, etc. For example, network tester 116 may determine that a network connection may be suitable for simple data exchanges in support of, for example, viewing web pages using a web browser and conducting voice communication, but may not have adequate speed, bandwidth, quality, etc. for conducting video communication. In addition, if any of the elements making up the network connection are visible to other users, the capability information may indicate that the network connection is not totally secure.

The capability information may then be provided to at least initiator device 102 as shown at 122. Initiator device 102 may utilize the capability information in providing a notification for the user and/or may provide the capability information to applications in initiator device 102. For example, the notification provided by initiator device 102 may be a graphic indicator of whether capabilities are supported by the network connection. The user may observe the graphic indicator and determine what action is required in view of the situation (e.g., seek out another connection method or location, reschedule an event, etc.). As a result, the “Existing Visibility” shown in FIG. 1, which is commonly available for the immediate connection between initiator device 102 and AP 104, may be expanded to include the disclosed “Enhanced Visibility” for the entire network connection from initiator device 102 to remote entity 114. With regard to sharing the capability information with applications, in one embodiment an application program interface (API), native platform hooks, etc. may be provided that allow applications (e.g., voice or video communication applications) to access the capability information. The applications may then use the information to customize operation (e.g., reduce sound and/or video quality, deactivate certain features with high bandwidth requirements, etc.), to advise the user of initiator device 102 how to proceed (e.g., make suggestions as to whether to conduct the communication, etc.), etc. Further to the above, in one embodiment the capability information may also be provided to the remote entity 114, which may utilize the information in a manner similar to initiator device 102.

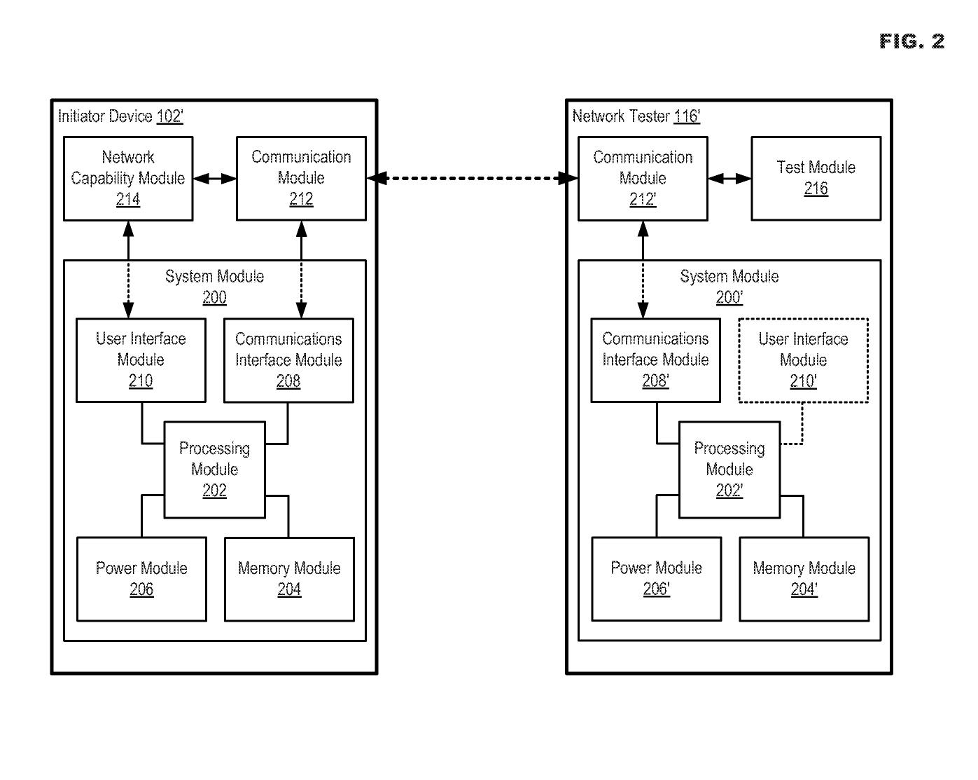

FIG. 2 illustrates an example initiator device 102′ and network tester 116′ usable with at least one embodiment of the present disclosure. Generally, initiator device 102′ and network tester 116′ may comprise circuitry capable of implementing the functionality illustrated in FIG. 1. System module 200 may be configured to perform various functions that may occur during normal operation of initiator device 102′. For example, processing module 202 may comprise one or more processors situated in separate components, or alternatively, may comprise one or more processing cores situated in a single component (e.g., in a System-on-a-Chip (SOC) configuration). Example processors may include various X86-based microprocessors available from the Intel Corporation including those in the Pentium, Xeon, Itanium, Celeron, Atom, Core i-series product families. Processing module 202 may be configured to execute instructions in initiator device 102′. Instructions may include program code configured to cause processing module 202 to perform activities related to reading data, writing data, processing data, formulating data, converting data, transforming data, etc. Information (e.g., instructions, data, etc.) may be stored in memory module 204. Memory module 204 may comprise random access memory (RAM) or read-only memory (ROM) in a fixed or removable format. RAM may include memory configured to hold information during the operation of initiator device 102′ such as, for example, static RAM (SRAM) or Dynamic RAM (DRAM). ROM may include memories such as bios memory configured to provide instructions when device 102′ activates, programmable memories such as electronic programmable ROMs, (EPROMS), Flash, etc. Other fixed and/or removable memory may include magnetic memories such as floppy disks, hard drives, etc., electronic memories such as solid state flash memory (e.g., eMMC, etc.), removable memory cards or sticks (e.g., uSD, USB, etc.), optical memories such as compact disc-based ROM (CD-ROM), etc. Power module 206 may include internal (e.g., battery) and/or external (e.g., wall plug) power sources and module configured to supply initiator device 102′ with the power needed to operate. Communications interface module 208 may be configured to handle packet routing and various control functions for communication module 212, which may include various resources for conducting wired and/or wireless communications. Wired communications may include mediums such as, for example, Universal Serial Bus (USB), Ethernet, etc. Wireless communications may include, for example, close-proximity wireless mediums (e.g., radio frequency (RF), infrared (IR), etc.), short-range wireless mediums (e.g., Bluetooth, wireless local area networking (WLAN), etc.) and long range wireless mediums (e.g., cellular, satellite, etc.). For example, communications interface module 208 may be configured to prevent wireless communications active in communication module 212 from interfering with each other. In performing this function, communications interface module 208 may schedule activities for communication module 212 based on the relative priority of the pending messages.

User interface module 210 may include module configured to allow a user to interact with initiator device 102′ such as, for example, various input mechanisms (e.g., microphones, switches, buttons, knobs, keyboards, speakers, touch-sensitive surfaces, one or more sensors configured to capture images and/or sense proximity, distance, motion, gestures, etc.) and output mechanisms (e.g., speakers, displays, indicators, electromechanical components for vibration, motion, etc.). In one embodiment, network capability module 214 may interact with at least user interface module 210 and communication module 212. Network capability module 214 may be configured to cause communication module 212 to transmit a message to network tester 116′, the message requesting initiation of testing for a network connection. In one embodiment the message transmitted to network tester 116 may identify both initiator device 102′ and remote entity 114. Moreover, network capability module 214 may be further configured to receive capability information from network tester 116′ via communication module 212, and to interact with user interface module 210 to provide notification to the user of the capabilities that are currently supported by the network connection. For example, network capability module 214 may cause user interface module 210 to display a graphic indicator of the currently supported capabilities.

Network tester 116′ may comprise at least all of the components previously described in regard to initiator module 102′, identified as modules 200′-208′ and 212′ in network tester 116′, with the exception of user interface module 210′ and network capability module 214. User interface module 210′ may be optional if, for example, network tester 116′ is simply a web server. Network capability module 214 may be replaced by test module 216 in network tester 116′. Test module 216 may be configured to receive messages requesting the initiation of testing for a network connection via communication module 212′. In conducting testing of the network connection, test module 216 may also be configured cause test information to be transmitted via communication module 212′, and to receive the test information via communication module 212′. During the transmission and reception of the test information, test module 216 may monitor the performance of the network connection. Test module 216 may then be configured to determine capability information based on the monitored performance, and to cause communication module 212′ to transmit the capability information to at least initiator device 102′.

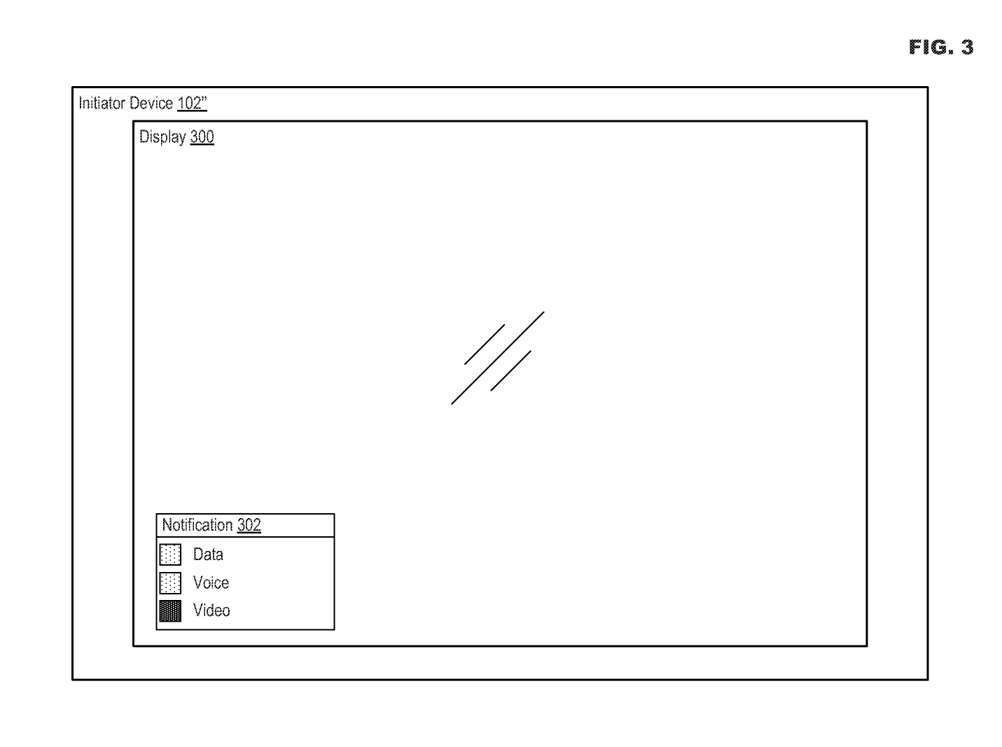

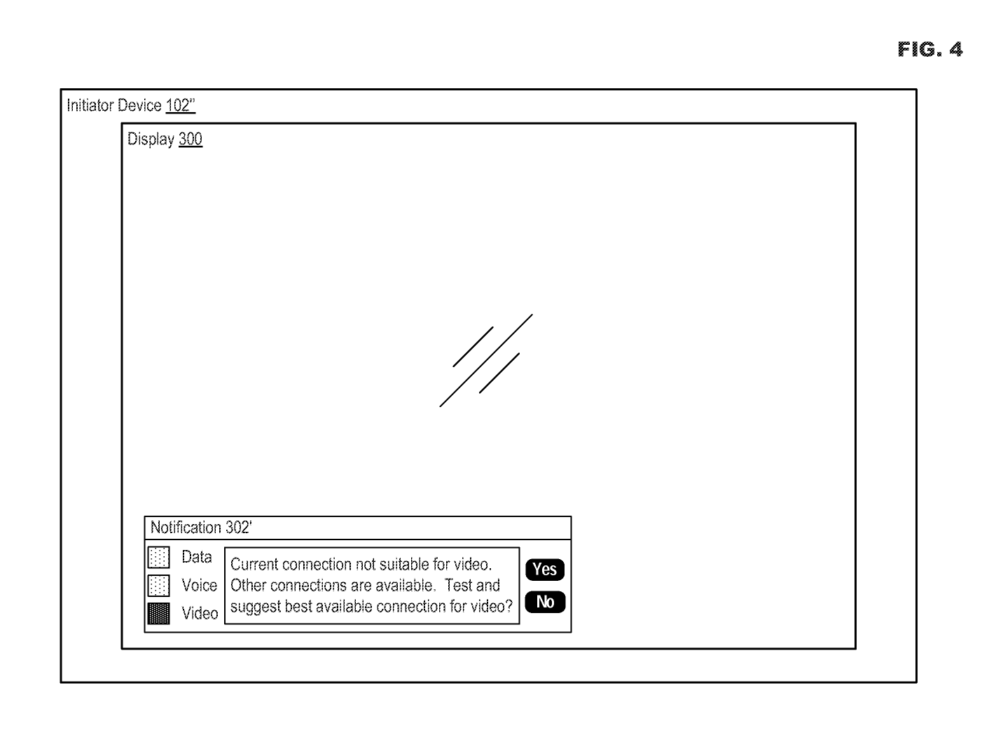

FIG. 3 illustrates an example user interface in accordance with at least one embodiment of the present disclosure. Initially, it is important to note that while FIGS. 3 and 4 disclose particular embodiments of user interfaces, the user interface of FIGS. 3 and 4 are only intended as an example for the purpose of explanation herein. Other user interface elements (e.g., sound, lit and/or flashing indicators, motion, etc.) may also be used in providing notification of the capability information. Further, the particular layout or operation of notifications 302 or 302′ may vary based upon, for example, the particular user interface configuration in initiator device 102″ (e.g., the size and resolution of display 300), the number of capabilities for which notification is required, if notification 302 or 302′ is integrated into another application, aesthetic preferences, etc.

Initiator device 102″ may include display 300 (e.g., as part of user interface module 210). Display 300 may employ any technology (e.g., cathode ray tube (CRT), Plasma, liquid crystal display (LCD), light emitting diode (LED), active-matrix organic LED (AMOLED), etc.) that is able to displaying notification 302. Notification 302 may be a graphical indicator configured to notify the user of initiator device 102″ of the capabilities that are currently available, supported, etc. in a network connection based on capability information received from network tester 116. In the example of FIG. 3 notification contains color indicators corresponding to three example capabilities: data, voice and video. The light color shading corresponding to “data” and “voice” may indicate that these capabilities are currently supported by the network connection. The dark shading of the indicator next to “video” may indicate that the use of video communication is not recommended given the recently monitored performance of the network connection. For example, the speed or bandwidth may not be suitable for video communication, the quality of the connection (e.g., latency, loss, jitter, etc.) will result in unsatisfactory video performance, etc.

FIG. 4 illustrates an example user interface including suggestion functionality in accordance with at least one embodiment of the present invention. FIG. 4 discloses notification 302′ in a similar format to notification 302 with the addition of suggestion functionality. In one embodiment, notification 302′ may indicate that the current network connection does not support at least one capability (e.g., video as illustrated in FIG. 4), and that other network connections are available. Other available network connections may be determined, for example, utilizing existing wireless network detection schemes, from information (e.g., available via the Internet) regarding wired/wireless access in the current location of initiator device 102″, etc. Notification 302′ may also inquire as to whether the other available network connections should be tested so that the best available connection for video may be suggested. Notification 400 may also include a user interface allowing the user to respond to the inquiry (e.g., “Yes” or “No” as illustrated in FIG. 4). If the user responds affirmatively, initiator device 102″ may initiate testing for one or more of the other available network connections. If at least one of the other available network connections is capable of providing the desired capability (e.g., video as illustrated in FIG. 4), the initiator device 102″ may then take further action. Examples of further actions that may be undertaken by initiator device 102″ include, for example, displaying at least one suggestion of another available network connection that supports the desired capability (e.g., video), a list of other available network connections (e.g., in order of preferred use) that support the desired capability, automatically switching to another available network connection, etc.

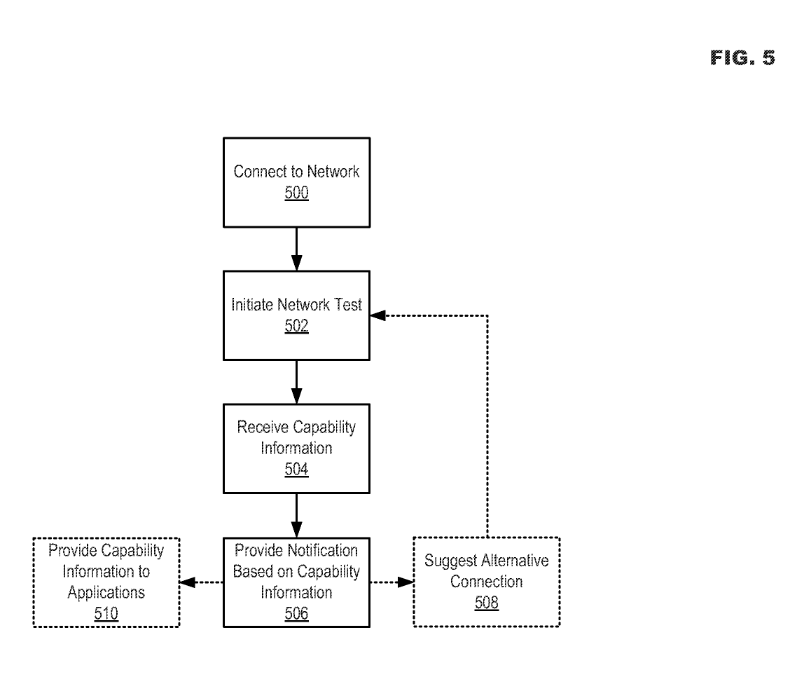

FIG. 5 is a flowchart of example operations for network capability notification from the initiator device perspective in accordance with at least one embodiment of the present disclosure. In operation 500 a network connection may be initiated. In at least one embodiment, initiation of a network connection may cause a test for a network connection to be initiated in operation 502. For example, initiator device 102 may transmit a message to network tester 116, the message requesting the initiation of a test for the network connection. The results of the testing (e.g., capability information) may then be received in operation 504. The capability information may be utilized to provide notification (e.g., to the user of initiator device 102) in operation 506. For example, the notification may be a graphical indicator as to whether capabilities are supported by the network connection. Further, optional operations 508 and/or 510 may also be performed. In optional operation 508 a suggestion may be made as to an alternative connection. For example, the initiator device may notify a user that the current network connection lacks a capability and that other available network connections exist. The user may then cause initiator device 102 to test one or more of the other available network connections, as illustrated by the arrow returning to operation 502, and to suggest at least one of the other available network connections having the desired capability. In optional operation 510 the capability information may be provided to applications in initiator device 102. Operation 510 may be performed if, for example, the test initiation in operation 400 was prompted (e.g., caused) by an application in initiator device 102.

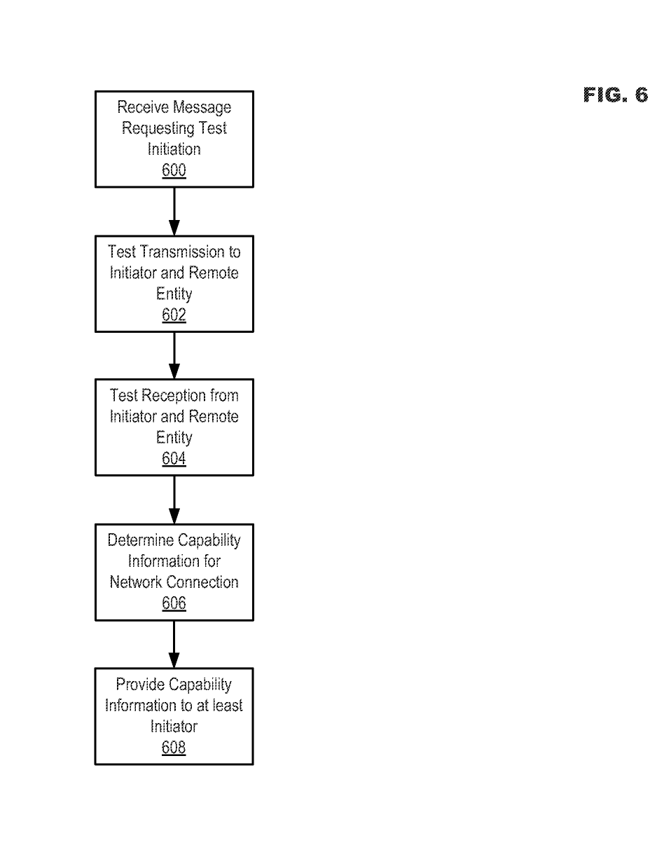

FIG. 6 is a flowchart of example operations for network capability notification from the network tester perspective in accordance with at least one embodiment of the present disclosure. In operation 600 a message may be received (e.g., in network tester 116), the message requesting the initiation of a test for a network connection. For example, the message may be received from initiator device 102 and may at least identify initiator device 102 and remote entity 114. Testing may begin in operation 602 with test information being transmitted to initiator device 102 and remote entity 114. Network tester 116 may monitor the performance of the network connection during the transmission. Test information may then be received from initiator device 102 and remote entity 114 into network tester 114, which may again monitor performance, in operation 604. Capability information may then be determined in operation 606, the capability information being determined based on the monitored performance of the network connection during testing. In operation 608 the capability information determined in operation 606 may be provided to at least initiator device 102. In one embodiment, the capability information may also be provided to remote entity 114.

While FIGS. 5 and 6 illustrate various operations according to different embodiments, it is to be understood that not all of the operations depicted in FIGS. 5 and 6 are necessary for other embodiments. Indeed, it is fully contemplated herein that in other embodiments of the present disclosure, the operations depicted in FIGS. 5 and 6, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, the present disclosure provides systems and methods for network capability notification. An initiator device may transmit a message to a network tester requesting initiation of testing of a network connection between the initiator device and a remote entity. The network tester may perform testing including the transmission of test information to, and the reception of test information from, the initiator device and the remote entity. The network tester may monitor the performance of the network connection during testing, and based on the performance may determine capability information. The capability information may then be provided to at least the initiator device. The initiator device may use the performance information to notify the user of the initiator device as to whether capabilities are supported by the network connection and/or to notify about other available network connections, to suggest a network connection, etc. The initiator device may also provide the capability information to applications, which may utilize the capability information in configuring operation, etc.

The following examples pertain to further embodiments. In one example embodiment there is provided an initiator device. The initiator device may include a communication module configured to link the initiator device to at least a remote entity via a network connection, a network capability module configured to initiate a test in a network tester for the network connection and to receive capability information for the network connection from the network tester, and a user interface module configured to provide a notification regarding the capabilities of the network connection based on the capability information.

The above example initiator device may be further configured, wherein the communication module is further configured to, in response to the network connection being initiated, cause the network capability module to initiate the test.

The above example initiator device may be further configured, wherein the network connection comprises at least local area networks associated with each of the initiator device and the remote entity and a wide area network connecting the local area networks.

The above example initiator device may be further configured, wherein the network capability module communicates with the network tester via the communication module by transmitting a message to the network tester requesting initiation of a test and identifying the initiator device and the remote entity.

The above example initiator device may be further configured, wherein the network tester comprises a server accessible via a wide area network.

The above example initiator device may be further configured, wherein the notification comprises a graphical indicator of whether the capabilities are supported by the network connection, the graphical indicator including at least one of whether data, voice or video is supported by the network connection.

The above example initiator device may be further configured, wherein the notification comprises a graphical indication that other network connections are available and an offer to test the other network connections in response to user input into the user interface module, the network capability module being further configured to initiate tests in the network tester for one or more of the other network connections and to display a suggestion of at least one of the other network connections based on the user input into the user interface module.

The above example initiator device may be further configured to comprise at least one application configured to cause the network capability module to initiate the network test, the network capability module being further configured to make the capability information available to the at least one application.

In another example embodiment there is provided a network tester. The network tester may include a communication module configured to at least receive a message from an initiator device, the message requesting initiation of a test configured to determine capability information for a network connection between the initiator device and a remote entity, and a test module configured to cause the communication module to transmit test information to the initiator device and remote entity, to cause the communication module to receive the test information from the initiator device and remote entity, and to cause the communication module to transmit the capability information to at least the initiator device.

The above example network tester may be further configured, wherein the network tester comprises a server accessible via a wide area network.

The above example network tester may be further configured, wherein the test module is further configured to monitor performance for the transmission and reception of the test information and to determine the capability information based on the monitored performance. In this example configuration, the network tester may be further configured, wherein monitoring performance includes monitoring at least one of speed, bandwidth, quality or security for the network connection.

In another example embodiment there is provided a method. The method may include transmitting a message requesting initiation of a test to a network tester, the test being configured to determine capability information for a network connection, receiving capability information from the network tester, and providing a notification regarding the capabilities of the network connection based on the capability information.

The above example method may further comprise initiating the network connection prior to transmitting the message, the initiation of the network connection causing the message to be transmitted.

The above example method may be further configured, wherein the message is transmitted from an initiator device to the network tester comprising a server accessible via a wide area network, the message further identifying the initiator device and a remote entity.

The above example method may be further configured, wherein providing the notification comprises displaying a graphical indicator of whether the capabilities are supported by the network connection, the graphical indicator including at least one of whether data, voice or video is supported by the network connection.

The above example method may be further configured, wherein providing the notification comprises displaying a graphical indication that other network connections are available and an offer to test the other network connections in response to user input into the user interface module, at least one additional message being transmitted, the at least one additional message requesting tests for one or more of the other network connections and to display a suggestion of at least one of the other network connections based on the user input into the user interface module.

The above example method may further configured to comprise making the capability information available to at least one application.

In another example embodiment there is provided a method. The method may include receiving a message, the message requesting initiation of a test configured to determine capability information for a network connection, transmitting test information, receiving the test information, determining capability information based on the transmission and reception of the test information, and transmitting the capability information.

The above example method may be further configured, wherein the message identifies an initiator device and a remote entity and the network connection is between the initiator device and the remote entity. In this example configuration the above method may be further configured, wherein the test information is transmitted to, and received from, the initiator device and the remote entity. In this example configuration the above method may be further configured, wherein the capability information is transmitted to at least the initiator device.

The above example method may be further configured to comprise monitoring performance for the transmission and reception of the test information, the determination of the capability information being based on the monitored performance. In this example configuration the above method may be further configured, wherein monitoring the performance includes monitoring at least one of speed, bandwidth, quality or security for the network connection.

In another example embodiment there is provided a system comprising at least an initiator device, a remote entity and a network tester, the system being arranged to perform the method of any of the above example method claims.

In another example embodiment there is provided a chipset arranged to perform the method of any of the above example method claims.

In another example embodiment there is provided at least one machine readable medium comprising a plurality of instructions that, in response to be being executed on a computing device, cause the computing device to carry out the method of any of the above example method claims.

In another example embodiment there is provided an initiator apparatus, the initiator apparatus being arranged to perform the method of any of the above example initiator apparatus-related method claims.

In another example embodiment there is provided a network tester apparatus, the network tester apparatus being arranged to perform the method of any of the above example network tester apparatus-related method claims.

In another example embodiment there is provided an initiator device. The initiator device may include a communication module configured to link the initiator device to at least a remote entity via a network connection, a network capability module configured to initiate a test in a network tester for the network connection and to receive capability information for the network connection from the network tester, and a user interface module configured to provide a notification regarding the capabilities of the network connection based on the capability information.

The above example initiator device may be further configured, wherein the communication module is further configured to, in response to the network connection being initiated, cause the network capability module to initiate the test.

The above example initiator device may be further configured, wherein the network capability module communicates with the network tester via the communication module by transmitting a message to the network tester requesting initiation of a test and identifying the initiator device and the remote entity.

The above example initiator device may be further configured, wherein the notification comprises a graphical indicator of whether the capabilities are supported by the network connection, the graphical indicator including at least one of whether data, voice or video is supported by the network connection.

The above example initiator device may be further configured, wherein the notification comprises a graphical indication that other network connections are available and an offer to test the other network connections in response to user input into the user interface module, the network capability module being further configured to initiate tests in the network tester for one or more of the other network connections and to display a suggestion of at least one of the other network connections based on the user input into the user interface module.

The above example initiator device may be further configured, further comprising at least one application configured to cause the network capability module to initiate the network test, the network capability module being further configured to make the capability information available to the at least one application.

In another example embodiment there is provided a method. The method may include transmitting a message requesting initiation of a test to a network tester, the test being configured to determine capability information for a network connection, receiving capability information from the network tester, and providing a notification regarding the capabilities of the network connection based on the capability information.

The above example method may further comprise initiating the network connection prior to transmitting the message, the initiation of the network connection causing the message to be transmitted.

The above example method may be further configured, wherein the message is transmitted from an initiator device to the network tester comprising a server accessible via a wide area network, the message further identifying the initiator device and a remote entity.

The above example method may be further configured, wherein providing the notification comprises displaying a graphical indicator of whether the capabilities are supported by the network connection, the graphical indicator including at least one of whether data, voice or video is supported by the network connection.

The above example method may be further configured, wherein providing the notification comprises displaying a graphical indication that other network connections are available and an offer to test the other network connections in response to user input into the user interface module, at least one additional message being transmitted, the at least one additional message requesting tests for one or more of the other network connections and to display a suggestion of at least one of the other network connections based on the user input into the user interface module.

The above example method may further comprise making the capability information available to at least one application.

In another example embodiment there is provided a system comprising at least an initiator device, a remote entity and a network tester, the system being arranged to perform the method of any of the above example method claims.

In another example embodiment there is provided a chipset arranged to perform the method of any of the above example method claims.

In another example embodiment there is provided at least one machine readable medium comprising a plurality of instructions that, in response to be being executed on a computing device, cause the computing device to carry out the method of any of the above example method claims.

In one example embodiment there is provided an initiator device. The initiator device may include a communication module configured to link the initiator device to at least a remote entity via a network connection, a network capability module configured to initiate a test in a network tester for the network connection and to receive capability information for the network connection from the network tester, and a user interface module configured to provide a notification regarding the capabilities of the network connection based on the capability information.

The above example initiator device may be further configured, wherein the communication module is further configured to, in response to the network connection being initiated, cause the network capability module to initiate the test.

The above example initiator device may be further configured, wherein the network connection comprises at least local area networks associated with each of the initiator device and the remote entity and a wide area network connecting the local area networks.

The above example initiator device may be further configured, wherein the network capability module communicates with the network tester via the communication module by transmitting a message to the network tester requesting initiation of a test and identifying the initiator device and the remote entity.

The above example initiator device may be further configured, wherein the network tester comprises a server accessible via a wide area network.

The above example initiator device may be further configured, wherein the notification comprises a graphical indicator of whether the capabilities are supported by the network connection, the graphical indicator including at least one of whether data, voice or video is supported by the network connection.

The above example initiator device may be further configured, wherein the notification comprises a graphical indication that other network connections are available and an offer to test the other network connections in response to user input into the user interface module, the network capability module being further configured to initiate tests in the network tester for one or more of the other network connections and to display a suggestion of at least one of the other network connections based on the user input into the user interface module.

The above example initiator device may be further configured to comprise at least one application configured to cause the network capability module to initiate the network test, the network capability module being further configured to make the capability information available to the at least one application.

In another example embodiment there is provided a network tester. The network tester may include a communication module configured to at least receive a message from an initiator device, the message requesting initiation of a test configured to determine capability information for a network connection between the initiator device and a remote entity, and a test module configured to cause the communication module to transmit test information to the initiator device and remote entity, to cause the communication module to receive the test information from the initiator device and remote entity, and to cause the communication module to transmit the capability information to at least the initiator device.

The above example network tester may be further configured, wherein the network tester comprises a server accessible via a wide area network.

The above example network tester may be further configured, wherein the test module is further configured to monitor performance for the transmission and reception of the test information and to determine the capability information based on the monitored performance. In this example configuration, the network tester may be further configured, wherein monitoring performance includes monitoring at least one of speed, bandwidth, quality or security for the network connection.

In another example embodiment there is provided a method. The method may include transmitting a message requesting initiation of a test to a network tester, the test being configured to determine capability information for a network connection, receiving capability information from the network tester, and providing a notification regarding the capabilities of the network connection based on the capability information.

The above example method may further comprise initiating the network connection prior to transmitting the message, the initiation of the network connection causing the message to be transmitted.

The above example method may be further configured, wherein the message is transmitted from an initiator device to the network tester comprising a server accessible via a wide area network, the message further identifying the initiator device and a remote entity.

The above example method may be further configured, wherein providing the notification comprises displaying a graphical indicator of whether the capabilities are supported by the network connection, the graphical indicator including at least one of whether data, voice or video is supported by the network connection.

The above example method may be further configured, wherein providing the notification comprises displaying a graphical indication that other network connections are available and an offer to test the other network connections in response to user input into the user interface module, at least one additional message being transmitted, the at least one additional message requesting tests for one or more of the other network connections and to display a suggestion of at least one of the other network connections based on the user input into the user interface module.

The above example method may further configured to comprise making the capability information available to at least one application.

In another example embodiment there is provided a method. The method may include receiving a message, the message requesting initiation of a test configured to determine capability information for a network connection, transmitting test information, receiving the test information, determining capability information based on the transmission and reception of the test information, and transmitting the capability information.

The above example method may be further configured, wherein the message identifies an initiator device and a remote entity and the network connection is between the initiator device and the remote entity. In this example configuration the above method may be further configured, wherein the test information is transmitted to, and received from, the initiator device and the remote entity. In this example configuration the above method may be further configured, wherein the capability information is transmitted to at least the initiator device.

The above example method may be further configured to comprise monitoring performance for the transmission and reception of the test information, the determination of the capability information being based on the monitored performance. In this example configuration the above method may be further configured, wherein monitoring the performance includes monitoring at least one of speed, bandwidth, quality or security for the network connection.

In another example embodiment there is provided a system. The system may include means for transmitting a message requesting initiation of a test to a network tester, the test being configured to determine capability information for a network connection, means for receiving capability information from the network tester, and means for providing a notification regarding the capabilities of the network connection based on the capability information.

The above example system may further comprise means for initiating the network connection prior to transmitting the message, the initiation of the network connection causing the message to be transmitted.

The above example system may be further configured, wherein the message is transmitted from an initiator device to the network tester comprising a server accessible via a wide area network, the message further identifying the initiator device and a remote entity.

The above example system may be further configured, wherein providing the notification comprises displaying a graphical indicator of whether the capabilities are supported by the network connection, the graphical indicator including at least one of whether data, voice or video is supported by the network connection.

The above example system may be further configured, wherein providing the notification comprises displaying a graphical indication that other network connections are available and an offer to test the other network connections in response to user input into the user interface module, at least one additional message being transmitted, the at least one additional message requesting tests for one or more of the other network connections and to display a suggestion of at least one of the other network connections based on the user input into the user interface module.

The above example system may further comprise means for making the capability information available to at least one application.

In another example embodiment there is provided a system. The system may include means for receiving a message, the message requesting initiation of a test configured to determine capability information for a network connection, means for transmitting test information, means for receiving the test information, means for determining capability information based on the transmission and reception of the test information, and means for transmitting the capability information.

The above example system may be further configured, wherein the message identifies an initiator device and a remote entity and the network connection is between the initiator device and the remote entity.

The above example system may be further configured, wherein the test information is transmitted to, and received from, the initiator device and the remote entity.

The above example system may be further configured, wherein the capability information is transmitted to at least the initiator device.

The above example system may further comprise means for monitoring performance for the transmission and reception of the test information, the determination of the capability information being based on the monitored performance. In this configuration the above example system may be further configured, wherein monitoring the performance includes monitoring at least one of speed, bandwidth, quality or security for the network connection.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. An initiator device, comprising:
a communication module configured to link the initiator device to at least a remote entity via a network connection;
a network capability module configured to initiate a test in a network tester for the network connection and to receive capability information for the network connection from the network tester; and
a user interface module configured to provide a notification regarding the capabilities of the network connection based on the capability information.

2. The initiator device of claim 1, wherein the communication module is further configured to, in response to the network connection being initiated, cause the network capability module to initiate the test.

3. The initiator device of claim 1, wherein the network connection comprises at least local area networks associated with each of the initiator device and the remote entity and a wide area network connecting the local area networks.

4. The initiator device of claim 1, wherein the network capability module communicates with the network tester via the communication module by transmitting a message to the network tester requesting initiation of a test and identifying the initiator device and the remote entity.

5. The initiator device of claim 1, wherein the network tester comprises a server accessible via a wide area network.

6. The initiator device of claim 1, wherein the notification comprises a graphical indicator of whether the capabilities are supported by the network connection, the graphical indicator including at least one of whether data, voice or video is supported by the network connection.

7. The initiator device of claim 1, wherein the notification comprises a graphical indication that other network connections are available and an offer to test the other network connections in response to user input into the user interface module, the network capability module being further configured to initiate tests in the network tester for one or more of the other network connections and to display a suggestion of at least one of the other network connections based on the user input into the user interface module.

8. The initiator device of claim 1, further comprising at least one application configured to cause the network capability module to initiate the network test, the network capability module being further configured to make the capability information available to the at least one application.

9. A network tester, comprising:
a communication module configured to at least receive a message from an initiator device, the message requesting initiation of a test configured to determine capability information for a network connection between the initiator device and a remote entity; and
a test module configured to cause the communication module to transmit test information to the initiator device and remote entity, to cause the communication module to receive the test information from the initiator device and remote entity, and to cause the communication module to transmit the capability information to at least the initiator device.

10. The network tester of claim 9, wherein the network tester comprises a server accessible via a wide area network.

11. The network tester of claim 9, wherein the test module is further configured to monitor performance for the transmission and reception of the test information and to determine the capability information based on the monitored performance.

12. The network tester of claim 11, wherein monitoring performance includes monitoring at least one of speed, bandwidth, quality or security for the network connection.

13. A method, comprising:
transmitting a message requesting initiation of a test to a network tester, the test being configured to determine capability information for a network connection;
receiving capability information from the network tester; and
providing a notification regarding the capabilities of the network connection based on the capability information.

14. The method of claim 13, further comprising initiating the network connection prior to transmitting the message, the initiation of the network connection causing the message to be transmitted.

15. The method of claim 13, wherein the message is transmitted from an initiator device to the network tester comprising a server accessible via a wide area network, the message further identifying the initiator device and a remote entity.

16. The method of claim 13, wherein providing the notification comprises displaying a graphical indicator of whether the capabilities are supported by the network connection, the graphical indicator including at least one of whether data, voice or video is supported by the network connection.

17. The method of claim 13, wherein providing the notification comprises displaying a graphical indication that other network connections are available and an offer to test the other network connections in response to user input into the user interface module, at least one additional message being transmitted, the at least one additional message requesting tests for one or more of the other network connections and to display a suggestion of at least one of the other network connections based on the user input into the user interface module.

18. The method of claim 13, further comprising making the capability information available to at least one application.

19. A system comprising at least one machine-readable storage medium having stored thereon, individually or in combination, instructions that when executed by one or more processors result in the following operations comprising:
transmitting a message requesting initiation of a test to a network tester, the test being configured to determine capability information for a network connection;
receiving capability information from the network tester; and
providing a notification regarding the capabilities of the network connection based on the capability information.

20. The system of claim 19, comprising further instructions that when executed by one or more processors result in additional operations including initiating the network connection prior to transmitting the message, the initiation of the network connection causing the message to be transmitted.

21. The system of claim 19, wherein the message is transmitted from an initiator device to the network tester comprising a server accessible via a wide area network, the message further identifying the initiator device and a remote entity.

22. The system of claim 19, wherein providing the notification comprises displaying a graphical indicator of whether the capabilities are supported by the network connection, the graphical indicator including at least one of whether data, voice or video is supported by the network connection.

23. The system of claim 19, wherein providing the notification comprises displaying a graphical indication that other network connections are available and an offer to test the other network connections in response to user input into the user interface module, at least one additional message being transmitted, the at least one additional message requesting tests for one or more of the other network connections and to display a suggestion of at least one of the other network connections based on the user input into the user interface module.

24. The system of claim 19, comprising further instructions that when executed by one or more processors result in additional operations including making the capability information available to at least one application.

25. A system comprising at least one machine-readable storage medium having stored thereon, individually or in combination, instructions that when executed by one or more processors result in the following operations comprising:
receiving a message, the message requesting initiation of a test configured to determine capability information for a network connection;
transmitting test information;
receiving the test information;
determining capability information based on the transmission and reception of the test information; and
transmitting the capability information.

26. The system of claim 25, wherein the message identifies an initiator device and a remote entity and the network connection is between the initiator device and the remote entity.

27. The system of claim 25, wherein the test information is transmitted to, and received from, the initiator device and the remote entity.

28. The system of claim 25, wherein the capability information is transmitted to at least the initiator device.

29. The system of claim 25, comprising further instructions that when executed by one or more processors result in additional operations including monitoring performance for the transmission and reception of the test information, the determination of the capability information being based on the monitored performance.

30. The system of claim 29, wherein monitoring the performance includes monitoring at least one of speed, bandwidth, quality or security for the network connection.
